(19) United States
(12) Patent Application Publication
(10) Pub. No.: US 2019/0334187 A1
(43) Pub. Date: Oct. 31, 2019

(54) METHOD AND SYSTEM FOR CONTROLLING AIR SUPPLY TO FUEL CELL

(71) Applicants: Hyundai Motor Company, Seoul (KR); Kia Motors Corporation, Seoul (KR)

(72) Inventors: Seung Yoon Lee, Seoul (KR); Sae Byeok Seung, Seosan (KR); Jeong Kyu Park, Yongin (KR); Sang Chul Yeom, Yongin (KR)

(21) Appl. No.: 16/155,007

(22) Filed: Oct. 9, 2018

(30) Foreign Application Priority Data
Apr. 26, 2018 (KR) 10-2018-0048313

(51) Int. Cl. H01M 8/04746; H01M 8/04537; H01M 16/00

(52) U.S. Cl. CPC H01M 8/04753; H01M 8/04626; H01M 16/006; H01M 8/04611

(57) ABSTRACT

An air supply control method of a fuel cell controls an amount of air supplied to the fuel cell according to an output of power required to be generated by the fuel cell. The method includes steps of: monitoring a charging level of a power storage device that stores power output from the fuel cell; modifying the amount of air supplied to the fuel cell on the basis of the monitored charging level of the power storage device; and controlling an air supply system that supplies air to the fuel cell on the basis of the modified amount of air supplied.

### CROSS REFERENCE TO RELATED APPLICATION

The present application claims under 35 U. S. C. § 119(a) the benefit of Korean Patent Application No. 10-2018-0048313, filed on Apr. 26, 2018, the entire contents of which are incorporated by reference herein.

### BACKGROUND

### 1. Technical Field

The present disclosure relates to a method and system for controlling air supply to a fuel cell, and more particularly, to the method for controlling air supply to the fuel cell based on a variation in charging level of a high-voltage battery in low flow control of the fuel cell.

### 2. Description of the Related Art

A fuel cell is a type of a power generator that converts chemical energy from fuel into electric power via an electrochemical reaction in a fuel cell stack, instead of heat through combustion, and may be employed not only to supply industrial, household, and vehicle-driving power but also to supply power to small-sized electrical and electronic products, particularly portable devices.

A fuel cell vehicle generates electric energy using the reaction of hydrogen and oxygen in a fuel cell. The generated electric energy may be used as a power source for the fuel cell vehicle by the vehicle driving a motor, or may be used for a power generation function of providing electric energy to a home, office, or factory via an externally connected power supply network.

A fuel cell system requires a chemical reaction that reacts air and hydrogen, and the performance and characteristics of the system are sensitive to humidity and the amount of air. Therefore, since the performance and characteristics of the system may be affected by internal or external factors, such as the changing state of a fuel cell stack, external temperature, the height of a vehicle, the driving habits of a driver, or the like, proper control is needed in response to the various internal and external factors.

Particularly, regarding low flow control conditions to minimize fuel loss in the fuel cell system and to improve the stability of the system, it is necessary to precisely adjust air introduced into the fuel cell stack. Under low flow control conditions, some of the power generated by the fuel cell system is consumed for the output of the motor, and the remaining power is used to charge the high-voltage battery.

However, a fuel cell vehicle cannot adequately respond to internal or external factors that occur, such as the state of health (SOH) of a fuel cell, outdoor temperature, and an altitude at which the vehicle is located, using a uniform control logic, thus making it impossible to maintain stability of the fuel cell system and to optimize fuel efficiency.

Details mentioned in the description of the prior art are only for the purpose of improving an understanding of the background of the present disclosure and should not be construed as corresponding to the prior art already known to those skilled in the art.

### SUMMARY

The present disclosure provides an air supply control method of a fuel cell system that feeds back a condition of the fuel cell system based on an environment thereof for optimization under various driving conditions, while taking into account internal or external environment changes of a fuel cell vehicle in low flow control of the fuel cell system.

In accordance with an aspect of the present disclosure, there is provided an air supply control method of a fuel cell that controls an amount of air supplied to the fuel cell according to an output of power required to be generated by the fuel cell, the method including: monitoring a charging level of a power storage device that stores power output from the fuel cell; modifying the amount of air supplied to the fuel cell on the basis of the monitored charging level of the power storage device; and controlling an air supply system that supplies air to the fuel cell on the basis of the modified amount of air supplied.

The method may further include: controlling the amount of air supplied to the fuel cell according to a map of the amount of air supplied to the fuel cell according to a preset output of power required to be generated by the fuel cell, before the monitoring of the charging level of the power storage device, wherein the modifying of the amount of air supplied include modifying the map of the amount of air supplied to the fuel cell according to the preset output of power required to be generated by the fuel cell.

The monitoring of the charging level of the power storage device may include monitoring a variation in the charging level of the power storage device per time.

The modifying of the amount of air supplied include modifying the amount of air supplied when a difference between a previous value of the variation in the charging level of the power storage device per time and a current value of the variation in the charging level of the power storage device per time is greater than a preset value.

The modifying of the amount of air supplied include modifying the amount of air supplied to decrease when the charging level of the power storage device increases.

The modifying of the amount of air supplied include modifying the amount of air supplied to increase when the charging level of the power storage device decreases.

The modifying of the amount of air supplied include modifying an APC angle of an air supply value formed in an air supply line for supplying air to the fuel cell, and the controlling of the air supply system may control the air supply value according to the modified APC angle of the air supply value.

The method may further include: determining whether the output of power required to be generated by the fuel cell is less than a preset output value before the monitoring of the charging level of the power storage device, wherein the charging level of the power storage device may be monitored when the output of power required to be generated by the fuel cell is less than the preset output value.

In accordance with an aspect of the present disclosure, there is provided an air supply control system of a fuel cell, the system including: a fuel cell that outputs power generated through a reaction of hydrogen and oxygen; an air supply system that supplies air to the fuel cell; a power storage device that stores the power output from the fuel cell; and a controller that controls an amount of air supplied to the fuel cell according to an output of power required to be generated by the fuel cell, monitors a charging level of the power storage device, modifies the amount of air supplied to the fuel cell on the basis of the monitored charging level of the power storage device, and controls the air supply system on the basis of the modified amount of air supplied.

The controller may monitor a variation in the charging level of the power storage device per time, and may modify the amount of air supplied to decrease when the variation in the charging level of the power storage device per time increases.

The controller may monitor a variation in the charging level of the power storage device per time, and may modify the amount of air supplied to increase when the variation in the charging level of the power storage device per time decreases.

The air supply system may include an air supply valve formed in an air supply line for supplying air to the fuel cell, and the controller may modify an APC angle of the air supply valve on the basis of the monitored charging level of the power storage device and may control the air supply valve according to the modified APC angle of the air supply valve.

The controller may determine whether the output of power required to be generated by the fuel cell is less than a preset output value, and may monitor the charging level of the power storage device when the output of power required to be generated by the fuel cell is less than the preset output value.

In accordance with an aspect of the present disclosure, there is provided a non-transitory computer readable medium containing program instructions executed by a processor, the computer readable medium including: program instructions that monitor a charging level of a power storage device that stores power output from a fuel cell; program instructions that modify the amount of air supplied to the fuel cell on the basis of the monitored charging level of the power storage device; and program instructions that control an air supply system that supplies air to the fuel cell on the basis of the modified amount of air supplied.

According to an air supply control method and an air supply control system of a fuel cell according to the present disclosure, it is possible to maintain an optimal state of an optimizing control logic of a fuel cell system despite changes in internal conditions including the state of a fuel cell stack or external conditions.

Accordingly, it is possible to achieve the optimal fuel efficiency of the fuel cell system and to consistently maintain the stability of the system, thereby improving the marketability.

Further, the durability of components in the fuel cell system may be improved and the potential for failure in the components by environmental changes may be reduced.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a flowchart illustrating an air supply control method of a fuel cell according to an exemplary embodiment of the present disclosure;

FIGS. 2 and 3 illustrate an APC angle map of an air supply value according to an exemplary embodiment of the present disclosure;

FIG. 4 illustrates the configuration of an air supply control system of a fuel cell according to an exemplary embodiment of the present disclosure;

FIG. 5 (RELATED ART) illustrates a driving state of a fuel cell system according to the related art; and

FIG. 6 illustrates a driving state of a fuel cell system according to the present disclosure.

### DETAILED DESCRIPTION OF THE EXEMPLARY EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

A specific structural or functional description of embodiments of the present disclosure disclosed in the specification or application is given merely for the purpose of describing the embodiment according to the present disclosure. Therefore, the embodiments according to the present disclosure may be implemented in various forms, and the present disclosure should not be construed as being limited to the embodiments described in the specification or application.

Various changes and modifications may be made to the embodiments according to the present disclosure, and therefore particular embodiments will be illustrated in the drawings and described in the specification or application. However, it should be understood that embodiments according to the concept of the present disclosure are not limited to the particular disclosed embodiments, but the present disclosure includes all modifications, equivalents, and alternatives falling within the spirit and scope of the present disclosure.

In the case where an element is referred to as being “connected” or “accessed” to other elements, it should be understood that not only the element is directly connected or accessed to the other elements, but also another element may exist between them. Meanwhile, in the case where a component is referred to as being “directly connected” or “directly accessed” to other component, it should be understood that there is no component therebetween. The other expressions of describing a relation between structural elements, i.e. “between” and “merely between” or “neighboring” and “directly neighboring”, should be interpreted similarly to the above description.

Unless defined differently, all terms used herein, which include technical terminologies or scientific terminologies, have the same meaning as that generally understood by a person skilled in the art to which the present disclosure belongs. It should be interpreted that the terms, which are identical to those defined in general dictionaries, have the meaning identical to that in the context of the related technique. The terms should not be ideally or excessively interpreted as a formal meaning unless not clearly defined.

Hereinafter, a preferred embodiment of the present disclosure will be described in detail with reference to the accompanying drawings. Similar reference numerals presented in the drawings indicate similar elements.

First, control of a fuel cell system of a fuel cell vehicle during driving may be largely classified into idle stop control, low flow control, and normal driving control. Idle stop control is control to block power generation of a fuel cell stack in a start-up state of the vehicle, in which supply of air to the fuel cell stack is blocked in order to minimize fuel loss.

Normal driving control is performed when a certain level or greater of output of power generation from the fuel cell stack is required, in which air is supplied to the fuel cell stack to such an extent that all cells in the fuel cell stack can be activated. Low flow control is performed when less than a certain level of output of power generation from a fuel cell stack is required, in which all cells in the fuel cell stack are not activated, but a tiny amount of power can be generated when a very low level of power generation is required. In low flow control, only a small amount of air is supplied to the fuel cell stack.

Low flow control includes constant-current driving in which the vehicle is driven by a motor and a blower not requiring greater power but using both the charged power of a high-voltage battery and power generated from the fuel cell stack when a motor and a blower do not require great power and the charged amount of the high-voltage battery is sufficient, and may include control to charge the high-voltage battery without the motor not consuming power when the vehicle stops. In addition, low flow control may be performed to quickly activate the fuel cell stack when small power is required but required power from the fuel cell stack is expected to increase subsequently.

Generally, in low flow control, an air blower is driven at a constant rotation speed. The constant rotation speed may be the minimum rotation speed of the air blower. Further, the APC angle of an air supply valve formed in an air supply line for supplying air to the fuel cell stack may be controlled depending on the current required from the fuel cell stack, thereby controlling the amount of air supplied to the fuel cell stack.

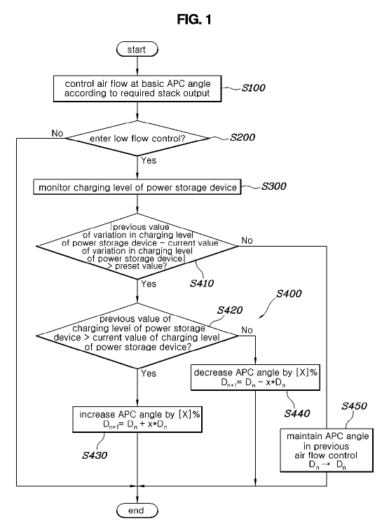

FIG. 1 is a flowchart illustrating an air supply control method of a fuel cell according to an exemplary embodiment of the present disclosure.

Referring to FIG. 1, the air supply control method of the fuel cell according to the exemplary embodiment of the present disclosure, which controls the amount of air supplied to the fuel cell according to the output of power required to be generated thereby, includes: an operation S300 of monitoring the charging level of a power storage device that stores power output from the fuel cell; an operation S400 of modifying the amount of air supplied to the fuel cell on the basis of the monitored charging level of the power storage device; and an operation (not shown) of controlling an air supply system that supplies air to the fuel cell on the basis of the monitored amount of air supplied.

In particular, the amount of air supplied to the fuel cell may be modified on the basis of the monitored charging level of the power storage device and the air supply system may be controlled accordingly, thereby maintaining an optimal state of an optimizing control logic of a fuel cell system despite changes in internal conditions including the state of a fuel cell stack and external conditions.

The method further includes an operation S200 of determining whether the output of power required to be generated by the fuel cell 10 is less than a preset output value before the operation S300 of monitoring the charging level of the power storage device, and may include monitoring the charging level of the power storage device when the output of power required to be generated by the fuel cell is less than the preset output value.

That is, it may be first determined whether the control state of a fuel cell system is low flow control by determining whether the output of power required to be generated thereby is less than the preset output value. When the fuel cell system is in the low flow control state, the fuel cell system may control the amount of air supplied to the fuel cell depending on the output of power required to be generated thereby, may monitor the charging level of the power storage device, and may modify the amount of air supplied to the fuel cell.

The method further includes an operation S100 of controlling the amount of air supplied to the fuel cell according to a map of the amount of air supplied to the fuel cell according to the preset output of power required to be generated thereby before the operation S300 of monitoring the charging level of the power storage device, and the operation S400 of modifying the amount of air supplied may include modifying the map of the amount of air supplied to the fuel cell according to the preset output of power required to be generated thereby.

That is, a map of the amount of air supplied to a fuel cell according to the output of power conventionally required to be generated thereby may be preset, the charging level of the power storage device may be monitored while controlling the amount of air supplied to the fuel cell according to the preset map of the amount of air supplied, and the preset map of the amount of air supplied may be modified on the basis of the monitored charging level of the power storage device.

In the operation S300 of monitoring the charging level of the power storage device, a variation ΔS in the charging level of the power storage device per time may be monitored. Specifically, the difference between the previous value of the variation in the charging level of the power storage device per time and the current value of the variation in the charging level of the power storage device per time may be monitored. The variation ΔS in the charging level of the power storage device may be periodically measured or may be periodically measured in an accumulative manner from the start of low flow control.

In the operation S400 of modifying the amount of air supplied, as illustrated below, when the difference between the previous value

$$\frac{Δ {S}_{n - 1}}{Δ {T}_{n - 1}}$$

of the variation in the charging level of the power storage device per time and the current value

$$\frac{Δ {S}_{n}}{Δ {T}_{n}}$$

of the variation in the charging level of the power storage device per time is greater than a preset value C (S410), the amount of air supplied may be modified (S430 and S440).

$$\vert \frac{Δ {S}_{n - 1}}{Δ {T}_{n - 1}} - \frac{Δ {S}_{n}}{Δ {T}_{n}} \vert > C$$

On the contrary, when the difference between the previous value

$$\frac{Δ {S}_{n - 1}}{Δ {T}_{n - 1}}$$

of the variation in the charging level of the power storage device per time and the current value

$$\frac{Δ {S}_{n}}{Δ {T}_{n}}$$

of the variation in the charging level of the power storage device per time is the preset value C or less, which is insignificant, it may be determined that external or internal conditions are not substantially changed and thus the amount of air supplied does not need to be modified, and accordingly the amount of air supplied may be controlled not to be modified (S450).

The operation S400 of modifying the amount of air supplied may include modifying the amount of air supplied to increase when the charging level of the power storage device decreases and may include modifying the amount of air supplied to decrease when the charging level of the power storage device increases. Specifically, the previous value Sₙ₋₁ of the charging level of the power storage device and the current value Sₙ of the charging level of the power storage device may be compared (S420). When the previous value Sₙ₋₁ of the charging level of the power storage device is greater than the current value Sₙ, the amount of air supplied may be modified to increase (S430).

On the contrary, when the previous value Sₙ₋₁ of the charging level of the power storage device is smaller than or equal to the current value Sₙ, the amount of air supplied may be modified to decrease (S440). That is, the operation S400 of modifying the amount of air supplied may include modifying the amount of air supplied to decrease (S440) when the variation in the charging level of the power storage device increases (S420).

In another exemplary embodiment, as illustrated in the following equation, the previous value of the variation in the charging level of the power storage device per time may be compared with the current value, and the amount of air supplied may be modified to increase or decrease. Specifically, when the difference between the previous value

$$\frac{Δ {S}_{n - 1}}{Δ {T}_{n - 1}}$$

of the variation in the charging level of the power storage device and the current value

$$\frac{Δ {S}_{n}}{Δ {T}_{n}}$$

of the variation in the charging level of the power storage device per time is greater than a preset value C and when the previous value

$$\frac{Δ {S}_{n - 1}}{Δ {T}_{n - 1}}$$

of the variation in the charging level of the power storage device is smaller the current value

$$\frac{Δ {S}_{n}}{Δ {T}_{n}}$$

of the variation in the charging level of the power storage device per time, the amount of air supplied may be modified to decrease.

$$\vert \frac{Δ {S}_{n - 1}}{Δ {T}_{n - 1}} - \frac{Δ {S}_{n}}{Δ {T}_{n}} \vert < - C$$

On the contrary, the operation S400 of modifying the amount of air supplied may include modifying the amount of air supplied to increase when the variation in the charging level of the power storage device per time decreases (S430). That is, as illustrated in the following equation, when the difference between the previous value

$$\frac{Δ {S}_{n - 1}}{Δ {T}_{n - 1}}$$

of the variation in the charging level of the power storage device and the current value

$$\frac{Δ {S}_{n}}{Δ {T}_{n}}$$

of the variation in the charging level of the power storage device per time is greater than the preset value C and when the previous value

$$\frac{Δ {S}_{n - 1}}{Δ {T}_{n - 1}}$$

of the variation in the charging level of the power storage device is greater the current value

$$\frac{Δ {S}_{n}}{Δ {T}_{n}}$$

of the variation in the charging level of the power storage device per time, the amount of air supplied may be modified to increase.

$$\vert \frac{Δ {S}_{n - 1}}{Δ {T}_{n - 1}} - \frac{Δ {S}_{n}}{Δ {T}_{n}} \vert > C$$

The operation S400 of modifying the amount of air supplied may include modifying the APC angle of an air supply value formed in an air supply line for supplying air to the fuel cell (S430, S440, and S450), and the operation (not shown) of controlling the air supply system may control the air supply value according to the modified APC angle of the air supply value.

As described above, in low flow control, an air blower may be driven at a constant rotation speed, and the amount of air supplied to the fuel cell may be controlled by controlling the APC angle of the air supply value formed in the air supply line for supplying air to the fuel cell.

That is, the map of the amount of air supplied to the fuel cell according to the preset output of power required to be generated thereby may be an APC angle map of the air supply value according to the output of power required to be generated thereby, and the operation S400 of modifying the amount of air supplied include modifying the amount of air supplied by modifying the APC angle of the air supply value, formed in the air supply line for supplying air to the fuel cell, to increase or decrease or by maintaining the APC angle of the air supply value. The operation (not shown) of controlling the air supply system may control the air supply value according to the modified APC angle of the air supply value.

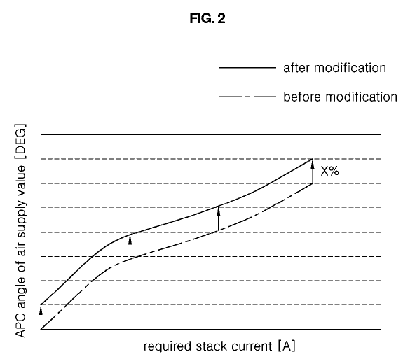

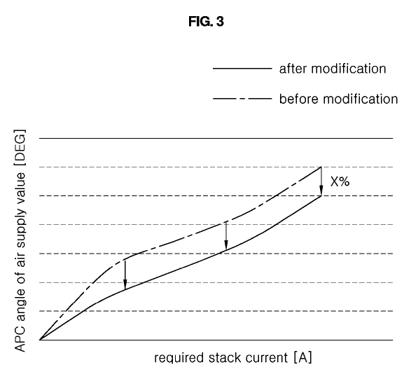

FIGS. 2 and 3 illustrate an APC angle map of an air supply value according to an exemplary embodiment of the present disclosure.

Referring to FIGS. 2 and 3, in the operation S400 of modifying the amount of air supplied, the APC angle of the air supply valve may be modified to increase by a certain percentage (x %) (S430) or to decrease by a certain percentage (x %) (S440).

Specifically, the APC angle of the air supply valve may be modified to increase by a certain percentage (x %) (S430) as in FIG. 2, or the APC angle of the air supply valve may be modified to decrease by a certain percentage (x %) (S440) as in FIG. 3.

Accordingly, to prevent the APC angle of the air supply valve from being suddenly modified to cause a significant disturbance to the amount of air supplied to the fuel cell, the APC angle of the air supply valve may be modified at a certain level, thereby maintaining the stability of control.

After the operation (not shown) of controlling the air supply system, the time to monitor the variation ΔS in the charging level of the power storage device may be reset. That is, the air supply valve may be controlled according to the APC angle map of the air supply valve according to the output of power required to be generated by the fuel cell, which is modified by modifying the amount of air supplied and resetting low flow control, to generate, after which the variation in the charging level of the power storage device may be monitored again and the APC angle map of the air supply valve may be modified.

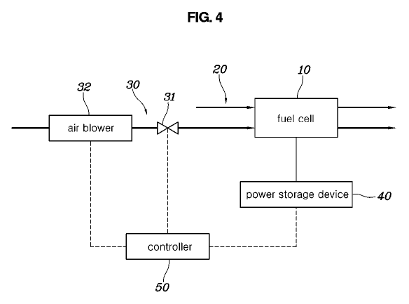

FIG. 4 illustrates the configuration of an air supply control system of a fuel cell according to an exemplary embodiment of the present disclosure.

Referring to FIG. 4, the air supply control system includes: a fuel cell 10 to output power generated through a reaction of hydrogen and oxygen; an air supply system 30 to supply air to the fuel cell 10; a power storage device 40 to store power output from the fuel cell 10; and a controller 50 to control the amount of air supplied to the fuel cell 10 according to the output of power required to be generated by the fuel cell 10, to monitor the charging level of the power storage device 40, to modify the amount of air supplied to the fuel cell 10 on the basis of the monitored charging level of the power storage device 40, and to control the air supply system 30 on the basis of the monitored amount of air supplied.

Specifically, the controller 50 may monitor a variation in the charging level of the power storage device 40 per time, and may modify the amount of supplied air to decrease when the variation in the charging level of the power storage device 40 per time increases.

Further, the controller 50 may monitor a variation in the charging level of the power storage device 40 per time, and may modify the amount of supplied air to increase when the variation in the charging level of the power storage device 40 per time decreases.

The fuel cell 10 includes a hydrogen supply system 20 to supply hydrogen to an anode of a fuel cell stack and the air supply system 30 to supply air to a cathode of the fuel cell stack.

Specifically, the air supply system 30 includes an air supply valve 31 formed in an air supply line for supplying air from an air blower 32 to the fuel cell 10, and the controller 50 may modify the APC angle of the air supply valve 31 on the basis of the monitored charging level of the power storage device 40 and may control the air supply valve 31 according to the modified APC angle of the air supply valve 31. Here, the controller 50 may control the air blower 32 to rotate at fixed RPM.

The controller 50 may determine whether the output of power required to be generated by the fuel cell 10 is less than a preset output value, and may monitor the charging level of the power storage device 40 when the output of power required to be generated by the fuel cell 10 is less than the preset output value.

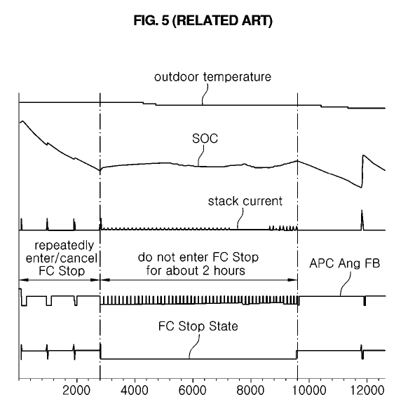

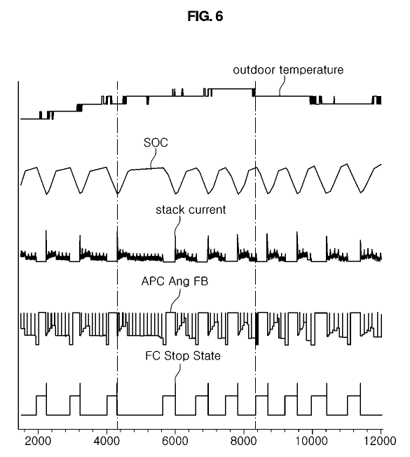

FIG. 5 illustrates a driving state of a fuel cell system according to the related art, and FIG. 6 illustrates a driving state of a fuel cell system according to the present disclosure.

Referring to FIG. 5, according to the related art, even though the internal state of a fuel cell or an external condition is changed in low flow control, the APC angle of an air supply valve is controlled to be constant according to a preset map depending on the required current (stack current) of a fuel cell stack. As a result, the fuel cell system repeatedly enters and cancels an FC Stop mode and then does not enter the FC Stop mode for about two hours. In low flow control, when the system does not enter the FC Stop mode, the system continuously consumes fuel, thus reducing fuel efficiency.

Referring to FIG. 6, however, in an air supply control method or an air supply control system of a fuel cell according to the present disclosure, when the internal state of the fuel cell or an external condition is changed in low flow control, the charging level (SOC) of a power storage device may be monitored and an APC angle map for an air supply valve is controlled to be varied accordingly, so that the system may nonnally repeatedly enter and cancel the FC Stop mode.

That is, according to the air supply control method or air supply control system of the fuel cell according to the present disclosure, it is possible to maintain an optimal state of an optimizing control logic of a fuel cell system.

Although the present disclosure has been described and illustrated with reference to the particular embodiments thereof, it will be apparent to those skilled in the art that various improvements and modifications of the present disclosure can be made without departing from the technical idea of the present disclosure provided by the following claims.

What is claimed is:

1. An air supply control method of a fuel cell that controls an amount of air supplied to the fuel cell according to an output of power required to be generated by the fuel cell, the method comprising:
monitoring, by a controller, a charging level of a power storage device that stores power output from the fuel cell;
modifying, by the controller, the amount of air supplied to the fuel cell on the basis of the monitored charging level of the power storage device; and
controlling, by the controller, an air supply system that supplies air to the fuel cell on the basis of the modified amount of air supplied.

2. The method of claim 1, further comprising:
controlling the amount of air supplied to the fuel cell according to a map of the amount of air supplied to the fuel cell according to a preset output of power required to be generated by the fuel cell, before the monitoring of the charging level of the power storage device,
wherein modifying the amount of air supplied includes modifying the map of the amount of air supplied to the fuel cell according to the preset output of power required to be generated by the fuel cell.

3. The method of claim 1, wherein monitoring the charging level of the power storage device includes monitoring a variation in the charging level of the power storage device per time.

4. The method of claim 3, wherein modifying the amount of air supplied includes modifying the amount of air supplied when a difference between a previous value of the variation in the charging level of the power storage device per time and a current value of the variation in the charging level of the power storage device per time is greater than a preset value.

5. The method of claim 3, wherein modifying the amount of air supplied includes modifying the amount of air supplied to decrease when the charging level of the power storage device increases.

6. The method of claim 3, wherein modifying the amount of air supplied includes modifying the amount of air supplied to increase when the charging level of the power storage device decreases.

7. The method of claim 1, wherein modifying the amount of air supplied includes modifying an APC angle of an air supply value formed in an air supply line for supplying air to the fuel cell, and
controlling the air supply system includes controlling the air supply value according to the modified APC angle of the air supply value.

8. The method of claim 1, further comprising:
determining whether the output of power required to be generated by the fuel cell is less than a preset output value before the monitoring of the charging level of the power storage device,
wherein the charging level of the power storage device is monitored when the output of power required to be generated by the fuel cell is less than the preset output value.

9. An air supply control system of a fuel cell, the system comprising:
a fuel cell that outputs power generated through a reaction of hydrogen and oxygen;
an air supply system that supplies air to the fuel cell;
a power storage device that stores the power output from the fuel cell; and
a controller that controls an amount of air supplied to the fuel cell according to an output of power required to be generated by the fuel cell, monitors a charging level of the power storage device, modifies the amount of air supplied to the fuel cell on the basis of the monitored charging level of the power storage device, and controls the air supply system on the basis of the modified amount of air supplied.

10. The system of claim 9, wherein the controller monitors a variation in the charging level of the power storage device per time, and modifies the amount of air supplied to decrease when the variation in the charging level of the power storage device per time increases.

11. The system of claim 9, wherein the controller monitors a variation in the charging level of the power storage device per time, and modifies the amount of air supplied to increase when the variation in the charging level of the power storage device per time decreases.

12. The system of claim 9, wherein the air supply system comprises an air supply valve formed in an air supply line for supplying air to the fuel cell, and the controller modifies an APC angle of the air supply valve on the basis of the monitored charging level of the power storage device and controls the air supply valve according to the modified APC angle of the air supply valve.

13. The system of claim 9, wherein the controller determines whether the output of power required to be generated by the fuel cell is less than a preset output value, and monitors the charging level of the power storage device when the output of power required to be generated by the fuel cell is less than the preset output value.

14. A non-transitory computer readable medium containing program instructions executed by a processor, the computer readable medium comprising:
program instructions that monitor a charging level of a power storage device that stores power output from a fuel cell;
program instructions that modify the amount of air supplied to the fuel cell on the basis of the monitored charging level of the power storage device; and
program instructions that control an air supply system that supplies air to the fuel cell on the basis of the modified amount of air supplied.
